(19) United States
(12) Patent Application Publication
(10) Pub. No.: US 2026/0287465 A1
(43) Pub. Date: Sep. 24, 2026

(54) INSPECTION APPARATUS AND INSPECTION METHOD FOR DETECTING ANOMALIES OF OPTICAL ELEMENTS OF AN ADDITIVE MANUFACTURING DEVICE

(71) Applicant: Nikon SLM Solutions AG, Luebeck (DE)

(72) Inventors: Philipp ROHSE, Luebeck (DE); Jan PAVLITA, Luebeck (DE)

(21) Appl. No.: 19/475,684

(22) PCT Filed: May 8, 2024
(86) PCT No.: PCT/EP2024/062684

§ 371 Date: Oct. 15, 2025

(30) Foreign Application Priority Data
May 12, 2023 (DE) 10 2023 112 669.5

(51) Int. Cl. G01M 11/02; B33Y 50/02

(52) U.S. Cl. CPC G01M 11/0207; B33Y 50/02

(57) ABSTRACT

The invention relates to an inspection apparatus (5) and an inspection method for examining an optical element (6) with respect to an anomaly (7), for use in an additive manufacturing device (1) for manufacturing a three-dimensional workpiece. The optical element (6) is disposed along an optical beam path formed by the irradiation system (8), between an irradiation source (10) of the irradiation system (8) and the irradiation plane (4). An illumination device (12) has at least one illumination source (13), which is configured such that it emits illumination beams (14) that generate at least one illumination pattern (15) on the optical element (6). A sensing device (16) is configured such that is senses a reflected beam which comprises at least a part of the illumination beams (14) that is reflected by the optical element (6). A control unit (18) is configured such that the illumination pattern (15) on the optical element (6) can be specified and that the control unit temporarily stores sensing data (20) which comprises data from the sensing device (16). The control unit (18) is also configured such that the sensing data (20) is recorded during illumination of the optical element (6) with different illumination patterns on an optical surface (11) of the optical element (6). Thus, the anomaly (7) of the optical element (6) can be presented as an optical anomaly feature (21) in the sensing data (20).

The invention relates to an inspection apparatus and to an inspection method for inspecting an optical element with respect to an anomaly of the optical element, for use in an additive manufacturing device for producing a three-dimensional workpiece by irradiating raw material powder layers in an irradiation plane with a processing beam emitted by an irradiation system. The optical element is here arranged along a beam path between an irradiation source of the irradiation system and the irradiation plane. The inspection apparatus has an illumination device, a sensing device and a control unit. The illumination device has at least one illumination source, which is configured such that it emits illumination beams that generate at least one illumination pattern on the optical element. The sensing device is configured such that it senses a reflected beam which comprises at least a part of the illumination beams that is reflected by the optical element. The control unit is configured such that the illumination pattern on the optical element can be specified by the control unit, and that it temporarily stores sensing data which comprise data from the sensing device.

The inspection apparatus and the inspection method are designed for example for use in the additive manufacturing device. The optical element is designed for example for use in the additive manufacturing device. The additive manufacturing device is designed for example to produce the three-dimensional workpiece by irradiating raw material powder layers in the irradiation plane with the processing beam emitted by the irradiation system. The sensing device is designed for example to sense or/and to generate the sensing data. The control unit is designed for example to control the illumination device in such a manner that the illumination device generates the at least one illumination pattern on the optical element.

Powder bed fusion is an additive layer-building process with which pulverulent, for example metallic and/or ceramic, raw materials can be processed to form three-dimensional workpieces with complex shapes. To this end, a raw material powder layer is applied to a carrier within an irradiation plane and is selectively irradiated, in dependence on the desired geometry, with electromagnetic radiation (for example laser radiation or particle radiation) in dependence on the desired geometry of the workpiece to be produced. The electromagnetic radiation that penetrates the powder layer leads to heating and thus to melting or sintering of the raw material powder particles. Further raw material powder layers are then applied in succession to the already irradiated and solidified layer on the carrier, until the workpiece has reached the desired shape and size. Powder bed fusion can be used to produce prototypes, tools, replacement parts, high-quality components for automotive construction or aviation, or for medical products. Examples of powder bed fusion methods are selective laser melting, selective laser sintering and electron beam melting.

Additive manufacturing devices for producing one or more workpieces by the above method are known from the prior art. For example, European patent application EP 2 961 549 A1 and European patent application EP 2 878 402 A1 describe an additive manufacturing device for producing a three-dimensional workpiece by the technique of selective laser melting. The system further comprises an irradiation device, which is equipped with a radiation source, for example a laser source, and with an optical system. The optical system serves to selectively guide a processing beam generated by the radiation source over the raw material powder layers applied to the carrier in dependence on the geometry of the workpiece to be produced. When building a three-dimensional workpiece by selectively irradiating the powder layers applied to the carrier, the radiation energy introduced into the raw material powder causes the powder particles to melt and/or sinter.

The optical elements in a beam path of an above-described additive manufacturing device within an irradiation system and/or optical system are subjected to high laser powers of from several hundred watts to several kilowatts. The processing beam, for example laser radiation, that leaves the irradiation system is collimated by collimation lenses to a certain raw beam diameter and deflected by means of deflection mirrors within the irradiation system and focused by means of focusing lenses. A high radiation intensity forms at the respective optical elements at the location at which the processing beam strikes. The radiation intensity describes a surface power density and is calculated as the power per unit area. The greater the power for the same area, the greater the intensity and vice versa.

As examples of optical elements in a beam path of the above-described additive manufacturing devices for the additive production of workpieces there may be mentioned protective screens, protective windows, coupling-in screens, coupling-in glasses, coupling-in windows, beam entry glasses, lenses or mirrors. Protective screens or protective glasses generally serve to maintain the optical elements arranged in the irradiation system in a clean environment and to protect them from process by-products, such as process waste gases or powder spatter particles, which form during the laser melting process. When the additive manufacturing device is used in the intended manner, these optical elements are arranged within the beam path of the processing beam and are subjected to the processing beam during operation of the additive manufacturing device.

It is particularly important to use optical elements that do not have any anomalies. Anomalies are to be understood in the following as being, for example, soiling or contamination of the optical element, such as, for example, dust particles, fluff, powder residues or other adhesions on the optical surface. In addition, an anomaly is also to be understood as being a penetration, a depression, an elevation, damage or an irregularity inside or outside the optical element. It is particularly important to install the optical elements carefully under clean and dust-free ambient conditions. Any foreign bodies, such as, for example, dust particles or fluff, enclosed in the installed irradiation system and/or optical system can become deposited on the optical surface of the protective glasses. If the optical element is subjected to laser power, the laser radiation can be absorbed at the foreign bodies, so that, in the worst case, both the anomaly and the optical element become heated and the optical element can be damaged by the resulting thermal heating. Heating of the optical element can also lead to the formation of a so-called thermal lens. The change in the refractive index that takes place within the material of the optical element can have the result that a position of the focal point of the processing beam is shifted, so that, in the worst case, the beam diameter of the processing beam within the irradiation plane is changed, which leads to a change in the radiation intensity within the irradiation plane, and the process stability of the melting process is influenced.

Another important criterion for reproducible and reliable operation of an additive manufacturing device is the cleanliness of the optical element for coupling the laser beam into the process chamber. Such an optical element, frequently also referred to as a beam entry glass, is generally arranged, when seen in the beam propagation direction, between the optical unit and the process chamber or the powder bed surface, or irradiation plane. The beam entry glass is here arranged such that a first surface of the protective glass points in the direction of the irradiation plane and a second surface of the protective glass points in the direction of the irradiation system. Furthermore, a focused beam, that is to say a beam that converges in the beam propagation direction, generally passes through the beam entry glass. A beam diameter of the laser beam incident upon the first surface or the second surface of the protective glass is thus smaller than the diameter of a raw beam leaving the collimation optic. The protective glass is thus subjected to a high intensity of the laser beam at the first surface and/or at the second surface in the region of the point of incidence. In order to reduce the risk of thermal damage to the protective glass at this point of incidence, it must be ensured prior to the start of a build job that the protective glass is clean and free of anomalies.

Depending on the ambient conditions and the installation location of the optical elements, it is difficult to check the protective glasses for the presence of anomalies. The degree of visibility of the anomaly is dependent to a large extent on the illumination situation and/or the illumination arrangement relative to the camera arrangement. A significant role is played here for example by the illumination conditions, such as illumination brightness, illumination color, illumination direction, ambient brightness and the orientation of the illumination source and the orientation of the camera. For the detection of one or more anomalies within the optical element and/or on the optical surface of the optical element, the illumination can be adapted, for example, such that the surface is illuminated laterally at as low an angle as possible, so that light reflected at the anomalies of the object is sensed by the camera as scattered light.

Manual detection methods for inspecting the optical elements are known, in which the optical elements are illuminated by a flashlight. A visual inspection of the protective glasses with respect to the presence of an anomaly is here carried out by manually illuminating the protective glasses. The visibility of an anomaly within the optical element and/or on the optical surface of the optical element is dependent to a large extent on the illumination situation. Since, in the case of a manual inspection, the examination result is thus also dependent to a large extent on the operator carrying out the inspection, the manual inspection does not generally allow a reproducible statement to be made, for example about the degree of soiling or the nature of the anomaly of the optical element.

An above-described advantageous illumination situation is generally not possible for the inspection of optical elements that are arranged in regions of the process chamber and/or of the irradiation system that are difficult to access, since the space conditions that are present do not permit such a camera and/or illumination arrangement.

The object of the present invention is regarded as being to provide an inspection apparatus and an inspection method with which it is possible to reproducibly detect anomalies that are present within the optical element and/or on the optical surface of the optical element.

This object is achieved according to the invention in that the control unit is further configured such that the sensing data are recorded during illumination of the optical element with mutually different illumination patterns on an optical surface of the optical element, so that the anomaly of the optical element can be represented as an optical anomaly feature in the sensing data.

The sensing data are recorded by the sensing device for example while the optical surface of the optical element is being illuminated with the mutually different illumination patterns. For example, only a single illumination pattern is radiated onto the optical surface at any one time. The mutually different illumination patterns are thus radiated onto the optical surface for example sequentially, or at different times. For example, the mutually different illumination patterns can scan the optical surface section by section.

The optical anomaly feature can be recognized for example on the basis of the sensing data. The sensing data can comprise a representation, for example an image, of the optical anomaly feature.

The sensing device can be designed to detect the illumination beams in one or more of the mentioned wavelength ranges. The sensing device can have an optical sensor, which is designed as a camera, image sensor, photodiode, etc. A corresponding optical sensor can be designed, for example, as a CCD sensor, as a CMOS sensor etc., with which the illumination beams reflected by the optical element can be sensed. The sensing data sensed by the sensing device can be stored in the form of an image, a photo or in the form of signal data.

The at least one illumination source of the illumination device can be designed as a light-emitting illumination source, such as, for example, a light-emitting diode (LED), a laser diode, etc. Preferably, the illumination source is designed such that it emits as the illumination beams preferably light in the visible wavelength range. Alternatively, however, further wavelength ranges, such as, for example, the infrared wavelength range or the ultraviolet wavelength range, are also conceivable.

Furthermore, it can be advantageous for the illumination device to have a beam-shaping element by means of which the illumination beams emitted by the illumination source are shaped to form the illumination pattern. The illumination beams can be widened, rectified or focused, for example, by the beam-shaping element. A shape or size of the illumination pattern generated on the optical surface of the optical element can thus be adjusted in a particularly advantageous manner.

By generating different illumination patterns, the illumination beams are reflected at least partially by the regions of the optical element that are illuminated by the illumination pattern, so that they are sensed by the sensing device. For example the illumination beams reflected at the foreign bodies, such as, for example, at the dust particles or soot particles, are then recognizable as the optical anomaly feature, in the form of differences in brightness in the sensing data.

By generating mutually different illumination patterns, illumination of the optical element with multiple, mutually different directions can be generated. The anomaly of the optical element illuminated by the illumination pattern is thus also illuminated with the illumination beams. By generating the sensing data in each case with mutually different illumination directions, the anomaly can be rendered visible by illuminating the anomaly with selected illumination patterns, while the anomaly is possibly not able to be represented in further sensing data. In such cases, it may not be possible to represent the anomaly if the illumination device and/or the sensing device are oriented relative to one another such that the reflected illumination beams cause a reflection that overlies the optical anomaly feature. In other words, this is the case if the reflected illumination beams recorded by the sensing unit in a first illumination pattern overlie, in their intensity, the intensity of the illumination beams reflected at the anomaly.

It is therefore provided in an advantageous configuration of the invention that the control unit is configured such that it decomposes the sensing data in each case into individual selection data and further processes only those selection data in which the anomaly is contained and can be represented as an optical anomaly feature. The determination of selection data that contain the anomaly as an optical anomaly feature can be carried out by manually checking the sensing data, or the selection data. In the case of a known orientation of the inspection apparatus relative to the optical element, the determination of the selection data can first take place manually, and on repeated inspection of the anomaly, those selection data that contain the anomaly as an optical anomaly feature are known. The determination of the selection data can thus be carried out particularly simply and quickly.

Alternatively, it can also be provided that the evaluation of the sensing data for determining the selection data takes place in that brightness values, intensity values, etc. are evaluated in respect of whether they exceed a specific definable brightness threshold value, intensity threshold value, etc. To this end, it may optionally be provided that the sensing data are evaluated in respect of the brightness values, intensity values, etc. using data processing and data evaluation programs and/or image processing programs and/or image evaluation programs. A computer-based and/or automated evaluation of the sensing data can thus be carried out before the determination of the selection data. It is thus possible to determine the optical anomaly features particularly simply and quickly.

In the case of a known and fixed arrangement and orientation of the illumination device relative to the sensing device, it is possible, after manual and/or automated evaluation of the sensing values has been carried out, to predetermine the selection data suitable for the representation of the anomaly. Depending on the chosen orientation, only the regions of the optical surface that are illuminated with the illumination pattern are relevant as selection data. Therefore, it may optionally also be provided that only a partial region of the optical surface, for example the region of the optical surface that is illuminated with the illumination pattern, is recorded by the sensing device. Particularly time-saving recording and resource-saving temporary storage of the sensing data can thus be implemented.

In the example of the sensing data recorded as multiple overall images, an overall image is in each case decomposed into multiple partial sections, wherein the location and the size of the partial sections are chosen such that they either contain an illumination condition that is disadvantageous for the evaluation, such as, for example, an interfering reflection which overlies the optical anomaly feature. Further partial sections can contain the optical anomaly feature and can be further processed in order to evaluate the soiling of the optical element.

For example, the sensing device can record an image of the entire optical surface each time the optical surface is irradiated with an illumination pattern, and can store this image. Each image can then be decomposed into respective partial sections, which then correspond to the selection data. The partial sections can be chosen in dependence on the respective illumination pattern. For example, each image is decomposed into one or more first partial sections and one or more second partial sections, wherein an illumination pattern is to be seen in each first partial section but not in any of the second partial sections. It is then conceivable to further process only the first partial sections, for example only those first partial sections in which an optical anomaly feature is recognizable. For example, all the first partial sections can thus be combined to form an overall image, and all the optical anomaly features can be identified on the basis of the overall image.

In order to obtain a general overview of the anomalies of the optical surface of the optical element to be inspected, it is provided in an advantageous implementation of the inventive concept that the control unit is further configured such that it combines the selection data to form an evaluation dataset. The entire optical surface of the optical element, in which the anomaly is visible as an optical anomaly feature, is thus represented in the evaluation dataset. The multiple partial sections which contain the optical anomaly feature are combined to form an overall evaluation image, so that an overall image of the optical surface with the anomalies present within the optical element and/or on the optical surface of the optical element is generated.

An evaluation of the optical anomaly in order to determine a degree of soiling of the optical element can be carried out in subsequent evaluation steps such that the optical anomaly feature is evaluated in respect of the size of the optical anomaly feature, the number of optical anomaly features per unit area and in respect of the nature of the optical anomaly feature. This can be carried out by means of known image processing methods and programs.

Each illumination pattern can be designed such that it does not cover the entire optical surface. The mutually different illumination patterns differ for example in terms of the regions of the optical surface that are covered by the illumination patterns.

In order to achieve particularly advantageous illumination of the optical element, it can be provided according to the invention that the illumination beams generate an illumination pattern with which the optical surface of the optical element is illuminated at least in some portions. By illuminating the optical surface in some portions, it can be avoided that illumination beams are reflected by the regions of the optical surface that are not illuminated, which would cause an interfering reflection. In the case where the arrangement of the illumination device relative to the optical surface is known beforehand, the region of the optical surface that is illuminated by the illumination pattern can be predetermined. By means of an additionally known arrangement of the sensing device relative to the optical surface, an evaluation of the sensing data can be carried out such that only the illuminated regions are evaluated. An evaluation of the optical surface with respect to the optical anomaly feature can thus be carried out in a particularly simple manner.

By illuminating the optical surface only in some portions, a quantity of light emitted by the illumination beams, said quantity being emitted by the illumination beams onto the optical surface, can be reduced. As a result, the quantity of light reflected at the optical surface or transmitted through the optical element is likewise small. Advantageously, the quantity of light which, as a result of reflection and/or transmission at the optical element, is in the environment of the optical element to be examined is likewise reduced. Interfering reflections, which are caused by illumination beams reflected at a process chamber wall, for example, or at an element of the irradiation system and/or of the optical system that is arranged in the background of the transparent optical element, can thus be reduced. An optical surface that does not contain anomalies can be sensed in the sensing data as a dark optical surface. An anomaly that is present in the illuminated region of the optical surface can thus be represented particularly well as an optical anomaly feature.

In order to design the illumination device so that it is particularly simple and inexpensive, it can be provided according to the invention that the optical surface of the optical element is illuminated completely by the illumination beams emitted by the illumination device. It is thus possible to dispense with complex orientation of the illumination device relative to the optical element, so that the inspection apparatus can be installed particularly easily and quickly.

According to an advantageous implementation of the inventive concept, it is provided that the optical surface of the optical element is sensed completely by the sensing device. It is thus ensured that edge regions of the optical element, in which anomalies may be present, are reliably also sensed. A complex orientation of the sensing device to the regions of the optical surface that are illuminated by the illumination pattern is thus not necessary.

The irradiation system containing the optical elements is generally mounted under clean and pure conditions, so that it is ensured that no anomaly is enclosed in the interior of the irradiation system during mounting of the irradiation system. In addition, the irradiation system is mostly closed in a gas-tight manner in order to protect the interior of the irradiation system from the ingress of, for example, dust particles from the surrounding atmosphere. An optical surface of the optical element that faces the irradiation system can thus no longer be reached from outside, for reasons relating to construction, and is thus less exposed to the risk of an anomaly than the optical surface of the optical element that is remote from the irradiation system.

For example, it is provided according to the invention to configure the inspection apparatus such that the illumination device and the sensing device are arranged on the same side of the optical element. This is because, depending on the structural form of the additive manufacturing device and depending on the arrangement of the optical elements within the irradiation system, accessibility to the optical elements within an additive manufacturing device is often difficult or in some cases not possible and, in the example case, is possible only from an optical surface of the optical element that is remote from the irradiation system.

For example the optical surface of an optical element, such as, for example, of the beam entry glass for guiding the processing beam into the interior of the process chamber, is exposed to the risk of an anomaly owing to the process by-products that form during the melting process, such as waste gases, stirred-up powder or soot formation. Thus, in a particularly advantageous configuration of the inspection apparatus, it is provided that the inspection apparatus is arranged on the side of the optical element that faces the irradiation plane or the optical surface opposite the irradiation system.

It is also possible and optionally provided according to the invention that the optical beam path forms an optical axis, wherein an optical path of the illumination beams is arranged inclined with respect to the optical axis of the inspection apparatus. The illumination beams can thus purposively be directed in a particularly simple manner into specific regions of the optical surface, so that the illumination pattern is incident upon the optical surface in dependence on the inclined arrangement.

Advantageously, it is optionally also provided according to the invention that the at least one illumination source is arranged offset perpendicularly with respect to the optical axis. The distance between the at least one illumination source and the optical axis can here be arranged in accordance with a set inclination of the illumination source and/or in accordance with the chosen working distance and/or in accordance with the existing space conditions. Particularly advantageous illumination of the optical element can thus be produced.

In an advantageous configuration of the invention, it is provided that the illumination beams can be activated in such a manner that they can be changed in each case individually and separately from one another in terms of illumination properties, such as in their intensity and/or in their wavelength. The illumination properties are here advantageously to be adjusted in dependence on the expected back reflections of the reflected illumination beams. The characteristic and the degree of the back reflections can vary in dependence on the reflection properties or transmission properties of the optical element. Accordingly, an illumination situation with low interfering reflections can be set by adaptation of the intensity and/or the wavelength of the.

The illumination device can be activated such that the illumination properties of the illumination beams are different between two or more of the illumination patterns.

According to the set illumination properties, such as, for example, the intensity of the illumination beams, the size of the range of the selection data which are further processed can be adapted or influenced. A set low intensity of the illumination beams can accordingly lead to low back reflection in specific regions, so that the size of the selection data, in which the anomaly can be represented as an anomaly feature and which are further processed, can be increased.

A variation of the wavelength of the illumination beams can advantageously be used to detect anomalies of different types and to distinguish them from one another. An anomaly on the optical element, such as dust residues, spatter particles, soot, etc., can thus be detected.

Advantageously, when using multiple illumination sources, a variation of the illumination properties of each individual illumination source can be set separately from one another in order to facilitate the desired effect as regards the generation of selection data that are as large as possible.

Depending on the configuration of the optical element, it can be advantageous to illuminate the optical surface with different illumination patterns. The illumination pattern can here on the one hand be adapted to the shape of the optical element. Advantageously, it is optionally provided according to the invention that the illumination pattern is point-shaped, strip-shaped or tile-shaped. An optical element can thus be illuminated in some regions or in some portions according to its shape. By means of strip-shaped illumination, the optical element is illuminated in some portions, so that the anomaly of the optical element are preferably contained in the illuminated regions and these are further processed as selection data to form a selection dataset. In addition, on an optical surface that is illuminated only partially by the illumination pattern, the anomaly can be represented in a large contrast ratio.

In an advantageous implementation of the inventive concept, it is provided that the inspection apparatus has at least one receiving element to which the illumination device and the sensing device can be fixed. By means of predefined positions and configurations of the receiving elements, the illumination device and the sensing device can be installed within the inspection apparatus easily and quickly. The receiving element can also be designed as a housing, which surrounds the illumination device and the sensing device at least partially. The optical elements surrounded by the housing are thus protected.

Inspection of the optical elements used in an additive manufacturing device can take place at different times during mounting and/or operation of the additive manufacturing device. The time of and the necessity for the inspection are determined on the basis of the type of optical element to be examined. For example, protective glasses of an irradiation system are examined with respect to the presence of anomalies after the protective glasses have been installed in the irradiation system. It can here be ensured that the optical elements fitted in the irradiation system are free of anomalies before the irradiation system is installed on an optical carrier or is installed in the additive manufacturing device, where accessibility to the optical elements is limited. Depending on the accessibility, an inspection can also take place after mounting in the additive manufacturing device is complete.

The beam entry glasses arranged in the process chamber cover are generally before the start of a building job and/or each time the beam entry glasses are cleaned in order to monitor the cleaning operation. In order to inspect the beam entry glasses, it can be provided according to the invention that the inspection apparatus is arranged within the process chamber in a region between the beam entry glasses and the irradiation plane. The process chamber housing could here be designed such that a receiver or a receiving recess is provided, in which the inspection apparatus can be arranged at least in part, so that the inspection apparatus is arranged outside the deflection regions of the deflected processing beams. The inspection apparatus is here arranged on the side of the optical element that faces the irradiation plane. An inspection of the optical surface, which is exposed to an increased risk of soiling by the process by-products that form during the melting process, can thus take place. In addition, by integrating the inspection apparatus within the process chamber, an inspection of the beam entry glasses can take place during a build job. To this end, the inspection operation can advantageously take place during the operation of applying a raw material powder layer, during which the irradiation system is switched off, so that the beam entry glasses can be inspected without pausing the build job.

Optionally, the inspection apparatus according to the invention can also be designed as a portable inspection apparatus which can releasably be arranged with the additive manufacturing device and/or the irradiation system. The inspection apparatus can be designed such that it can be arranged within the process chamber at a position beneath the beam entry glasses and within the beam path of the one or more irradiation systems. Such an arrangement of the inspection apparatus requires the inspection apparatus to be able to be removed from the beam path again after the optical elements have been inspected. To this end, it is provided in an advantageous configuration of the inspection apparatus according to the invention that the receiving element has a fixing means with which the receiving element can releasably be fixed to the additive manufacturing device and/or to the irradiation system. Suitable fixing means are releasable fixing means, such as, for example, screws, clamping levers, clamps, bolts, magnetic fastening means. For example, the inspection apparatus can be designed such that it can releasably be fixed within the process chamber of the additive manufacturing device to the carrier in the region of the irradiation plane and beneath the beam entry glasses. The region of the irradiation plane is generally readily accessible and reachable, so that manual mounting and dismounting of the inspection apparatus at a position within the irradiation plane are possible in a simple manner.

Advantageously, the receiving element is designed such that it can be brought into contact with a corresponding receiving element of the additive manufacturing device and/or of the irradiation system. Centering or orientation of the inspection apparatus can be carried out via known orientation means, such as centering pegs, bolts, sleeves, pins or rings. The inspection apparatus can thus be brought into a predefined position relative to the optical element in order releasably to fix the inspection device in the predefined position with the fastening means.

Advantageously, the fixing means can optionally be designed such that the inspection apparatus can be oriented in the predefined position relative to the optical element and can be fixed in a desired location and/or position. Rapid and reproducible introduction and orientation of the inspection apparatus relative to the optical element within the process chamber and/or within the optical element is thus possible.

During the irradiation of the optical element with two or more, for example all, illumination patterns (e.g. directly following one another), the illumination device and the sensing device can positioned in the same pose in relation to the optical element. At least the illumination device and the sensing device can thus be fixed in position in relation to the optical element during the recording of sensing data on the basis of at least two illumination patterns.

In an exemplary configuration, the inspection apparatus is designed such that each illumination beam forming an illumination pattern, said illumination beam being reflected by the optical element, for example by the optical surface irradiated with the illumination pattern, and reaching the sensing device, has an angle of incidence at the optical element that lies within a predetermined angle of incidence range or/and has an angle of reflection that lies within a predetermined angle of reflection range. The two angle ranges can be identical or different. Each angle range can lie between a minimum angle and a maximum angle, wherein the minimum angle is, for example, 15°, 10°, 5°, 4°, 3°, 2°, 1° or 0.5° or/and the maximum angle is, for example, 50°, 45°, 40°, 35°, 30°, 25°, 20°, 15°, 10°, 5°, 4°, 3°, 2° or 1°. The difference between the minimum angle and the maximum angle can be 5°, 10°, 15°, 20° or 25°.

It is conceivable that the illumination device and the sensing device are moved (e.g. together) in relation to the optical element (e.g. between the irradiation of the optical element with two successive irradiation patterns), in order to ensure that the illumination beams each have an angle of incidence that lies within the predetermined angle of incidence range or/and that the illumination beams reflected at the optical element have an angle of reflection that lies within the predetermined angle of reflection range. To this end, the illumination device and the sensing device can be arranged in the process chamber on a common movable holding apparatus. The holding apparatus can for example be designed to orient the illumination device and the sensing device in a positionally accurate manner in multiple predefined locations (e.g. in relation to the optical element). For example, in a first of these predefined locations, the illumination device and the sensing device can emit a first irradiation pattern onto the optical element and record corresponding sensing data and, after (e.g. manual) transfer into a second of these predefined locations, they can emit a second irradiation pattern onto the optical element and again record corresponding sensing data. It is here conceivable that the illumination device is activated in the same manner in both predefined locations, that is to say emits the same light pattern, wherein the regions covered by the illumination beams then differ owing to the difference in location.

It is likewise conceivable that the illumination device is moved in relation to the sensing device (e.g. between the irradiation of the optical element with two successive irradiation patterns) in order to ensure that the illumination beams each have an angle of incidence that lies within the predetermined angle of incidence range or/and have an angle of reflection that lies within the predetermined angle of reflection range. To this end, the illumination device or/and the sensing device can each be arranged in the process chamber on a movable positioning apparatus. Each positioning apparatus can for example be designed to orient the illumination device or the sensing device in a positionally accurate manner in multiple predefined locations (e.g. in relation to the optical element). For example, in a first of these predefined locations, the inspection apparatus can emit a first irradiation pattern onto the optical element and record corresponding sensing data and, after (e.g. manual) transfer into a second of these predefined locations, it can emit a second irradiation pattern onto the optical element and again record corresponding sensing data. It is here conceivable that the illumination device is activated in the same manner in both predefined locations, that is to say emits the same light pattern, wherein the regions of the optical surface that are covered by the illumination beams then differ owing to the difference in location.

It is of course also conceivable to use the inspection apparatus in a first of the predefined locations to inspect one or more first optical elements (e.g. protective glasses), and to move the inspection apparatus into a second of the predefined locations, for example by means of the holding apparatus, in order to inspect one or more second optical elements (e.g. further protective glasses). Depending on the embodiment, the illumination apparatus and the sensing device can here be repositioned together or separately from one another. Repositioning can in turn ensure that the desired angle ranges are maintained. If the angle ranges are the same for each sensing of the sensing data (e.g. image recording), this makes it easier for example to compare selection data (e.g. partial regions of different images).

In an exemplary configuration, the inspection apparatus is stored in a build cylinder, which is designed to be coupled to the process chamber. In addition to the inspection apparatus, other measuring devices or/and maintenance apparatuses can also be stored in the same build cylinder. For example, the inspection apparatus can be arranged (e.g. together with the further measuring devices or/and maintenance apparatuses) on a mounting plate that is axially displaceably mounted in the build cylinder. After the build cylinder has been coupled to the process chamber, the mounting plate can be displaced in the direction toward the process chamber by a drive system of the additive manufacturing device, for example until the mounting plate lies in the irradiation plane. The method described herein can then be carried out with the inspection apparatus so positioned in the process chamber. The build plate can then be moved back again, that is to say away from the process chamber, for example downward. The inspection apparatus is thus moved out of the process chamber and back into the build cylinder. The build cylinder with the inspection apparatus located therein can then be uncoupled and exchanged for a build cylinder designed to manufacture a three-dimensional workpiece. This approach has the advantage that the inspection apparatus does not have to be brought into the process chamber manually, and that the process chamber does not require a loading hatch of correspondingly large dimensions for manual introduction of the inspection apparatus.

The object set out at the beginning is also achieved by an inspection method for the visual representation of an anomaly present on an optical surface of the optical element. The inspection method is provided for use in an additive manufacturing device for producing a three-dimensional workpiece by irradiating raw material powder layers applied within an irradiation plane with a processing beam emitted by an irradiation system, wherein the optical element is arranged along an optical beam path formed by the irradiation system, between an irradiation source of the irradiation system and the irradiation plane. The inspection method comprises the following steps: (i) illuminating the optical element in order to generate an illumination pattern on the optical surface of the optical element, wherein, at the same time as the illumination step, (ii) a reflected beam is sensed, said beam comprising at least a part of the illumination beams that is reflected by the optical element, wherein (iii) the illumination pattern on the optical element can be predefined, and (iv) sensing data which comprise data from the sensing device are temporarily stored. The sensing data are recorded during illumination of the optical element with mutually different illumination patterns on an optical surface of the optical element, so that the anomaly of the optical element can be represented as an optical anomaly feature in the sensing data.

By means of the method according to the invention, the anomaly contained in the optical element and/or on the optical surface of the optical element can be sensed. The inspection method is preferably carried out before the start of the additive manufacturing device for manufacturing a build job. The beam entry glass or the multiple beam entry glasses of the process chamber can thus be checked with respect to the presence of an anomaly individually or temporally in succession.

In an advantageous configuration of the invention, it is provided that the sensing data are in each case decomposed into individual selection data, and only those selection data in which the anomaly is contained as an optical anomaly feature are further processed.

It is further possible and optionally provided according to the invention that the selection data are combined to form an evaluation dataset, so that the optical anomaly feature of the anomaly present within the optical element and/or on the optical surface of the optical element can be evaluated from the evaluation dataset. There is further provided a system which comprises the optical element and the inspection apparatus. An additive manufacturing device for producing a three-dimensional workpiece by irradiating raw material powder layers with a processing beam is also provided said device comprising the optical element and the inspection apparatus.

The object set out at the beginning is also achieved by an additive manufacturing device for producing a three-dimensional workpiece by irradiating raw material powder layers with a processing beam, wherein the additive manufacturing device comprises an inspection apparatus as claimed in any one of claims 1 to 13. The inspection apparatus is advantageously designed such that it is moved into the beam path before the start of the build process, so that the inspection method according to the invention can be carried out. On completion of the inspection method, the inspection apparatus is moved again and arranged outside the beam path of the processing beam, so that the beam path of the processing beam is freed and the processing beam can strike, unhindered, the raw material powder layer applied in the irradiation plane.

Further advantageous configurations of the invention will be explained with reference to exemplary embodiments shown in the drawings, in which:

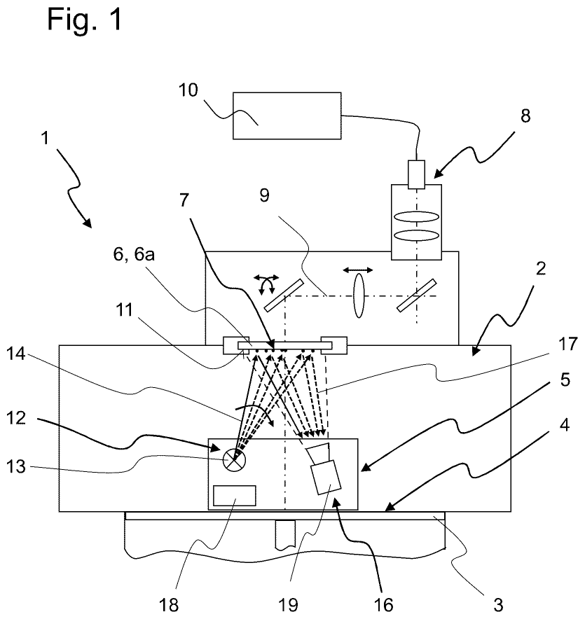

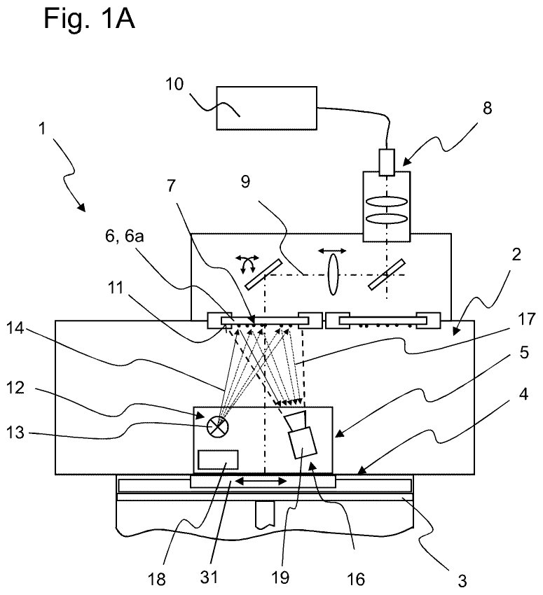

FIG. 1 shows a schematic representation of a detail of an additive manufacturing device with the inspection apparatus arranged within the process chamber,

FIG. 1a shows a schematic representation of a detail of a variant of the additive manufacturing device of FIG. 1 with a holding device for (re)positioning the inspection apparatus,

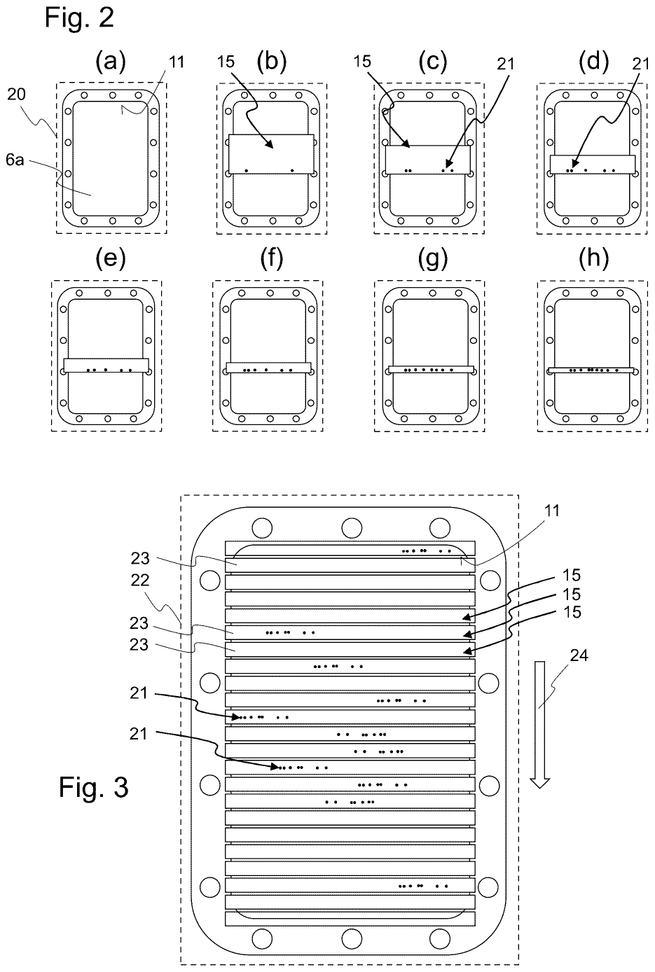

FIG. 2 shows a schematic representation of sensing data recorded by the inspection apparatus during illumination of the beam entry glass with different illumination patterns,

FIG. 3 shows a schematic representation of an evaluation dataset of combined selection data of the illuminated beam entry glass,

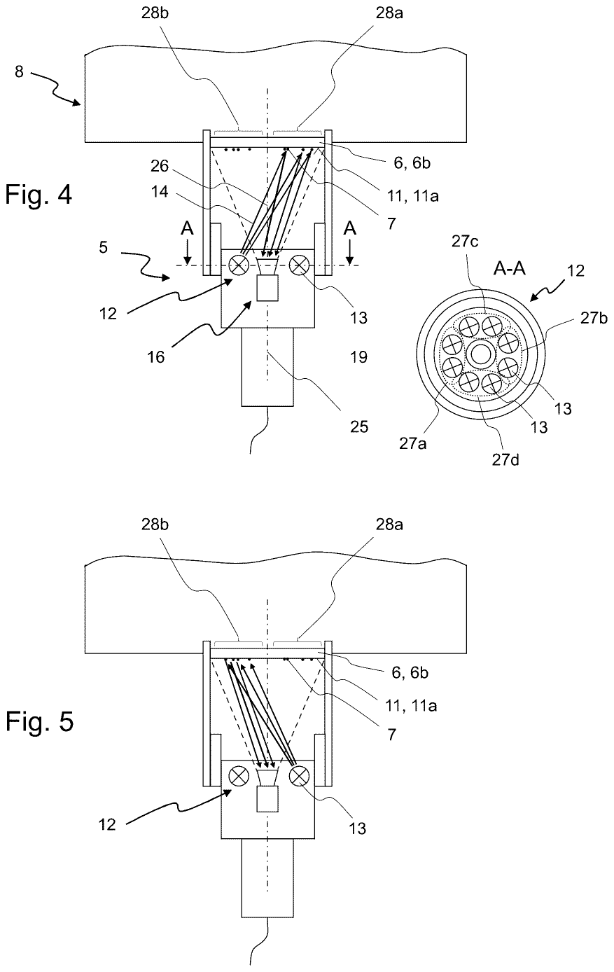

FIG. 4 shows a schematic representation of the inspection apparatus for inspecting the protective glass of an irradiation system in a first illumination situation,

FIG. 5 shows a schematic representation of the inspection apparatus for inspecting the protective glass of an irradiation system in a second illumination situation,

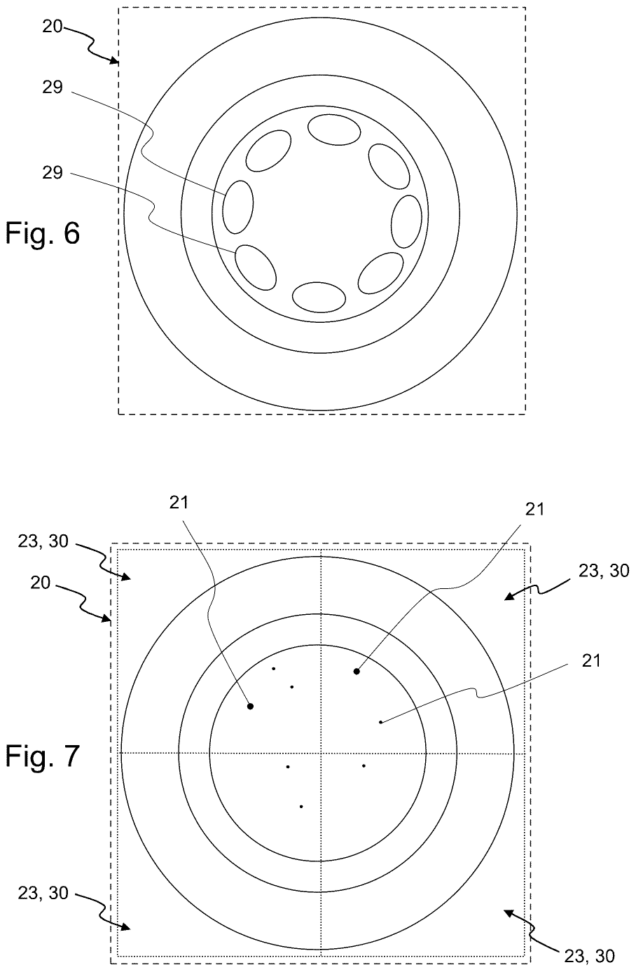

FIG. 6 shows a schematic representation of sensing data recorded by the inspection apparatus during illumination of the protective glass with all the illumination sources, and

FIG. 7 shows a schematic representation of an evaluation dataset of combined selection data of the illuminated protective glass.

FIG. 1 shows a schematic representation of a detail of an additive manufacturing device 1 with an inspection apparatus 5 arranged within a process chamber 2 and on a carrier 3 of the additive manufacturing device 1 within an irradiation plane 4.

The carrier 3 can be a build plate, which is displaceably mounted in a build cylinder, which can be coupled to the process chamber 2. It is thus conceivable to store the inspection apparatus 5 in a build cylinder in order to load it into the process chamber 2 from beneath after coupling of this build cylinder.

The inspection apparatus 5 is arranged within the process chamber 2 in order to examine an optical element 6, which in the present case is in the form of a beam entry glass 6a, with respect to one or more anomalies 7 of the optical element 6. The beam entry glass 6a is arranged in an optical beam path 9 formed by an irradiation system 8, between an irradiation source 10 of an irradiation system 8 and the irradiation plane 4. The beam entry glass 6a is oriented such that a first optical surface 11a of the beam entry glass 6a points in the direction toward the irradiation plane 4 and a second optical surface 11b of the beam entry glass 6a points in the direction toward the irradiation system 8. An illumination device 12 of the inspection apparatus 5 has an illumination source 13, which is configured such that it emits illumination beams 14, which generate an illumination pattern 15 on the optical element 6. In the exemplary embodiment shown in FIG. 1, the illumination source 13 is designed as a video projector, with which the illumination beams 14 can be generated in a predefinable illumination pattern 15 which illuminates the beam entry glass 6a in some portions on the first optical surface 11a. A sensing device 16 of the inspection apparatus 15 is configured such that it senses a reflected illumination beam 17, which comprises at least a part of the illumination beams 14 that is reflected by the optical element 6. A control unit 18 of the inspection apparatus 5 is configured such that the illumination beams 14 are directed at the optical surface 11 and the illumination pattern 15 is generated on the optical surface 11 of the optical element 6. The sensing device 16 has a camera 19, which records the first optical surface 11a of the optical element 6 and generates sensing data 20. The control unit 18 is configured such that the control unit 18 temporarily stores the sensing data 20, which comprise data of the sensing device 16. A recording is made of each illumination pattern 15 and is temporarily stored.

FIG. 2 shows a schematic representation of sensing data 20, in the form of individual images, recorded by the inspection apparatus 5. The sensing data 20 were generated during illumination of the beam entry glass 6a with different illumination patterns 15. The illumination pattern 15 in each case constitutes a strip-shaped illumination pattern 15, the strip width of which is reduced in each of the recordings shown in the individual images (a) to (h). By reducing the strip width of the illumination pattern 15, the visibility of the anomaly 7, which can be represented as an optical anomaly feature 21, on the first optical surface 11a is increased. This is because, by illuminating the optical surface 11 only in some portions, an interference-free recording of the optical surface 11 in the sensing data 20 recorded by the sensing device 16 is possible. Thus, the anomaly 7 can be represented on an optical surface 11 illuminated only partially by the illumination pattern 15 as a result of the large differences in brightness between the brightness of illumination beams 17 reflected at an anomaly 7 compared to the brightness of illumination beams 17 reflected at a clean region of the optical surface 11.

It can be advantageous for the angles of incidence and the angles of reflection of the illumination beams emitted onto the optical element and sensed by the sensing device to lie within predetermined angle ranges (e.g. in each case between 0° and 20°) at each sensing step, that is to say for each illumination pattern. In this case, the intensity of the reflected illumination beams received by the sensing device can also lie in a preferred range.

It is possible that a fixed position of the inspection apparatus 5 in the process chamber 2, while maintaining this(these) condition(s), has the result that only a part of the optical surface 11 can be illuminated by an illumination pattern and the reflected light thereof sensed. In order nevertheless to make it possible to inspect the entire the optical surface 11, the position of the inspection apparatus 5 in the process chamber 2 can be changed.

For example, the inspection apparatus 5 is arranged, as shown in FIG. 1A, on a holding apparatus 31, which defines a large number of predetermined positions of the inspection apparatus 5, between which the inspection apparatus 5 can be repositioned manually or driven by a motor. The holding apparatus 31 can be arranged on the carrier 3. For example, the holding apparatus 31 comprises a fastening portion fastened to the carrier 3 and a holding portion which is coupled thereto so as to be movable (e.g. rotationally or/and translationally) between the predetermined positions and which carries the inspection apparatus 5. For example, after inspection of a region of an optical element, the inspection apparatus can be moved in the x-direction or/and rotated about a perpendicular axis in order to inspect an illumination and sensing of a further region, spaced apart in the x-direction, of the optical element.

Movement of the inspection apparatus 5 is advantageous for example in the case of large-area optical elements or in the case of the inspection of multiple optical elements arranged spaced apart from one another. The additive manufacturing device 1 can thus comprise, for example, multiple beam entry glasses 6a. FIG. 1A shows by way of example two beam entry glasses 6a, which can be inspected after the inspection apparatus 5 has been correspondingly (re)positioned. It will be appreciated that the manufacturing device 1 can comprise further beam entry glasses 6a or other optical elements, which can then be inspected for example after the inspection apparatus 5 has been correspondingly (re)positioned. If the optical surfaces 11 to be inspected are sufficiently close to one another, repositioning of the inspection apparatus 5 between the inspection of the individual optical surfaces 11 may not be necessary, for example if the desired angle ranges can be maintained even if the position of the inspection apparatus 5 remains the same.

FIG. 3 shows a schematic representation of the evaluation dataset 22, which was generated by combined selection data 23 of the illuminated beam entry glass 6a. The optical surface 11 of the beam entry glass 6a was here illuminated in some portions and in temporal succession with a strip-shaped illumination pattern 15, and the illuminated optical surface 11 was recorded by the sensing device 16. After each recording, the strip-shaped illumination pattern 15 is arranged offset in the depicted offset direction 24, perpendicular to the strip-shaped illumination pattern 15, by a distance of preferably the strip width of the illumination pattern 15, in order to carry out a further recording of the optical surface 11. In an alternative embodiment, the inspection apparatus 5 can optionally be designed such that the strip-shaped illumination pattern 15 is guided continuously over the optical surface 11 and a recording of the optical surface 11 is carried out in dependence on the movement speed of the illumination pattern at time intervals. The optical surface 11 of the beam entry glass 6a is thus illuminated in some portions at each recording and is recorded in succession in all regions of the optical surface 11. A control unit 18, not shown in FIG. 3, is configured such that it decomposes the sensing data 20 into individual selection data 23 and further processes those selection data 23 in which the anomaly 7 is contained as an optical anomaly feature 21. In the present case, the selection data 23 that correspond to the illuminated region of the optical surface 11 are further processed.

FIG. 4 shows a schematic representation of the inspection apparatus 5 for inspecting an optical element 6, which is configured as a protective glass 6b, of an irradiation system 8 in a first illumination situation. The protective glass 6b shown in FIG. 4 serves to shield an interior of the irradiation system 8 with respect to an ambient atmosphere. To this end, the inspection apparatus 5 is inserted into an insertion bore of the irradiation system 8, into which a fiber end of the irradiation source 10, which is not shown in FIG. 4, is inserted when the irradiation system 8 is used in the intended manner. The illumination device 12, which is additionally shown in FIG. 4 in a sectional representation A-A, has in this example a total of eight illumination sources 13 arranged in a circle and coaxially with a longitudinal axis 25 of the inspection apparatus 5. The camera 19 of the sensing device 16 is arranged centrally on a bore longitudinal axis 26 and is oriented such that it senses the first optical surface 11a of the protective glass 6b. When the inspection apparatus 5 is used in the intended manner, the longitudinal axis 25 of the inspection apparatus 5 and the bore longitudinal axis 26 are identical. Since the insertion bore has a large ratio between a bore length and a bore diameter, and the bore diameter generally corresponds to a few millimeters or a few centimeters, illumination of the protective glass 6b arranged set back within the insertion bore is possible only with illumination beams 14 that are incident almost perpendicularly on the first optical surface 11a. Illumination from the side, which is advantageous, is not possible.

The inspection apparatus 5 shown in FIG. 4 is shown in a first illumination situation in which individual illumination sources 13 of a first illumination source group 27a, for example two illumination sources 13 adjacent to one another, of the illumination device 12 are switched on during a first recording. Illumination sources 13 of a second illumination source group 27b, third illumination source group 27c and fourth illumination source group 27d are switched off. The optical surface 11 is here illuminated by the illumination sources 13 of the first illumination source group 27a, so that an anomaly 7 present in a first illumination region 28a can be made visible, while an anomaly 7 present in a second illumination region 27b cannot be represented owing to interfering reflections 29.

In order, in the first illumination situation, to be able to represent in the sensing data 20 the anomaly 7 that cannot be represented, the first optical surface 11a is illuminated in a second illumination situation shown in FIG. 5. To this end, illumination sources 13 of a second illumination source group 27b are switched on and the illumination sources 13 of the first illumination source group 27a, of the third illumination source group 27c and of the fourth illumination source group 27d are switched off. The optical surface 11 is here illuminated by the illumination sources 13 of the first illumination source group 27b, so that the anomaly 7 present in the second illumination region 28b can be made visible, while the anomaly 7 present in the first illumination region 28a cannot be represented owing to interfering reflections 29. A third illumination situation and fourth illumination situation are then generated by switching on the illumination sources 13 of the third illumination source group 27c and fourth illumination source group 27d, and in each case sensing data 20 of the optical surface 11 are recorded, which is not shown in FIG. 4 and FIG. 5.

FIG. 6 shows a schematic representation of the sensing data 20, which was carried out with the inspection apparatus 5 shown in FIG. 4 and FIG. 5 during illumination of the protective glass 6b. The illumination sources 13 of all the illumination source groups 27 are switched on, which corresponds to illumination with a total of eight illumination sources 13. The anomaly 7 present on the optical surface 11 cannot be represented in this case, since the illumination device 12 and/or the sensing device 16 are so aligned relative to one another that multiple reflections 29 overlying the optical anomaly features 21 are caused by the reflected illumination beams 17.

FIG. 7 shows a schematic representation of the selection data 23 of the protective glass 6b, which have been combined to form an evaluation dataset 22. The sensing data 20 of the protective glass 6b have been generated during illumination of the protective glass 6b by the four mutually different illumination situations described above. The control unit 18 (not shown in FIG. 7) is configured such that it decomposes the sensing data 20 in each case into individual selection data 23 and further processes only those selection data 23 in which the anomaly 7 is contained as an optical anomaly feature 21. In the present case, an overall image of the optical surface 11 of the protective glass 6b is in each case decomposed into multiple partial sections 30, wherein the location and size of the partial sections 30 are so chosen that they do not contain an illumination condition that is disadvantageous for the evaluation, such as, for example, an interfering reflection 29 which overlies the optical anomaly feature 21. In the present case, the overall image has been divided into four partial sections 30, each of which constitutes a quadrant of the overall image. Those partial sections 30 in which a disturbing reflection 29 is contained are disregarded. The selection data 23 are combined to form an evaluation dataset 22, in which the entire optical surface 11 is represented and on which the optical anomaly features 21 are visible. An evaluation of the optical anomaly features 21 can subsequently be carried out by means of image evaluation programs in order to assess the degree of soiling of the protective glass 6b, for example by determining the size of the optical anomaly feature 21, by determining the number of optical anomaly features 21 per unit area and/or by determining the nature of the optical anomaly feature 21.

In each of the representations of FIGS. 1 to 7, only some of multiple elements of the same kind are identified by way of example with a reference sign.

1-17. (canceled)

18. An inspection apparatus for examining an optical element with respect to an anomaly of the optical element, for use in an additive manufacturing device for producing a three-dimensional workpiece by irradiating raw material powder layers applied within an irradiation plane with a processing beam emitted by an irradiation system, wherein the optical element is arranged along an optical beam path formed by the irradiation system, between an irradiation source of the irradiation system and the irradiation plane, wherein the inspection apparatus has an illumination device, a sensing device and a control unit, wherein
the illumination device has at least one illumination source, which is configured such that it emits illumination beams that generate at least one illumination pattern on the optical element, wherein
the sensing device is configured such that it senses a reflected beam which comprises at least a part of the illumination beams that is reflected by the optical element, wherein
the control unit is configured such that the illumination pattern on the optical element can be specified by the control unit, and wherein
the control unit is configured such that it temporarily stores sensing data which comprise data from the sensing device,
wherein
the control unit is further configured such that the sensing data are recorded during illumination of the optical element with mutually different illumination patterns on an optical surface of the optical element, so that the anomaly of the optical element can be represented as an optical anomaly feature in the sensing data.

19. The inspection apparatus as claimed in claim 18, wherein the control unit is configured such that it decomposes the sensing data in each case into individual selection data and further processes only those selection data in which the anomaly is contained as an optical anomaly feature.

20. The inspection apparatus as claimed in claim 19, wherein the control unit is configured such that it combines the selection data to form an evaluation dataset, so that the optical anomaly feature of the anomaly present within the optical element and/or on the optical surface of the optical element can be evaluated from the evaluation dataset.

21. The inspection apparatus as claimed in claim 18, wherein the optical surface of the optical element is illuminated at least in some portions by the illumination beams.

22. The inspection apparatus as claimed in claim 18, wherein the optical surface of the optical element is illuminated completely by the illumination beams.

23. The inspection apparatus as claimed in claim 18, wherein the optical surface of the optical element is sensed completely by the sensing device.

24. The inspection apparatus as claimed in claim 18, wherein the illumination device and the sensing device are arranged on the same side of the optical element.

25. The inspection apparatus as claimed in any claim 18, wherein the optical beam path forms an optical axis, wherein an optical path of the illumination beams is arranged inclined with respect to the optical axis of the inspection apparatus.

26. The inspection apparatus as claimed in claim 18, wherein the illumination beams can be activated in such a manner that they can be changed in each case individually and separately from one another in terms of illumination properties, such as in their intensity and/or in their wavelength.

27. The inspection apparatus of claim 25, wherein the at least one illumination source is arranged offset perpendicularly with respect to the optical axis.

28. The inspection apparatus as claimed in claim 18, wherein the illumination pattern is point-shaped, strip-shaped or tile-shaped.

29. The inspection apparatus as claimed in claim 18, wherein the inspection apparatus has at least one receiving element to which the illumination device and the sensing device can be fixed.

30. The inspection apparatus as claimed in claim 29, wherein the receiving element has a fixing means with which the receiving element can releasably be fixed to the additive manufacturing device and/or to the irradiation system.

31. An inspection method for examining an optical element with respect to an anomaly of the optical element, for use in an additive manufacturing device for producing a three-dimensional workpiece by irradiating raw material powder layers applied within an irradiation plane with a processing beam emitted by an irradiation system, wherein the optical element is arranged along an optical beam path formed by the irradiation system, between an irradiation source of the irradiation system and the irradiation plane, wherein the inspection method comprises the following steps:
i) illuminating the optical element in order to generate an illumination pattern on the optical surface of the optical element, wherein, at the same time as the illumination step,
ii) a reflected beam is sensed, said reflected beam comprising at least a part of the illumination beams that is reflected by the optical element, wherein
iii) the illumination pattern on the optical element can be predefined, and wherein
iv) sensing data which comprise data from the sensing device are temporarily stored,
wherein
the sensing data are recorded during illumination of the optical element with mutually different illumination patterns on an optical surface of the optical element, so that the anomaly of the optical element can be represented as an optical anomaly feature in the sensing data.

32. The inspection method as claimed in claim 31, wherein the sensing data are in each case decomposed into individual selection data and only those selection data in which the anomaly is contained as an optical anomaly feature are further processed.

33. The inspection method as claimed in claim 32, wherein the selection data are combined to form an evaluation dataset, so that the optical anomaly feature of the anomaly present within the optical element and/or on the optical surface of the optical element can be evaluated from the evaluation dataset.

34. An additive manufacturing device for producing a three-dimensional workpiece by irradiating raw material powder layers applied within an irradiation plane with a processing beam emitted by an irradiation system, the device comprising an inspection apparatus for examining an optical element with respect to an anomaly of the optical element, wherein the optical element is arranged along an optical beam path formed by the irradiation system, between an irradiation source of the irradiation system and the irradiation plane, wherein the inspection apparatus has an illumination device, a sensing device and a control unit, wherein
the illumination device has at least one illumination source, which is configured such that it emits illumination beams that generate at least one illumination pattern on the optical element, wherein
the sensing device is configured such that it senses a reflected beam which comprises at least a part of the illumination beams that is reflected by the optical element, wherein
the control unit is configured such that the illumination pattern on the optical element can be specified by the control unit, and wherein
the control unit is configured such that it temporarily stores sensing data which comprise data from the sensing device,
wherein
the control unit is further configured such that the sensing data are recorded during illumination of the optical element with mutually different illumination patterns on an optical surface of the optical element, so that the anomaly of the optical element can be represented as an optical anomaly feature in the sensing data.
